(19) United States
(12) Patent Application Publication
(10) Pub. No.: US 2026/0292205 A1
(43) Pub. Date: Sep. 24, 2026

(54) METHODS AND APPARATUS OF PROPAGATING MODELS FOR EXTRAPOLATION INTRA PREDICTION MODEL INHERITANCE IN VIDEO CODING

(71) Applicant: MEDIATEK INC., Hsinchu City (TW)

(72) Inventors: Hsin-Yi TSENG, Hsinchu City (TW); Cheng-Yen CHUANG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/473,438

(22) PCT Filed: Oct. 12, 2024
(86) PCT No.: PCT/CN2024/124329

§ 371 Date: Oct. 7, 2025

Related U.S. Application Data
(60) Provisional application No. 63/589,656, filed on Oct. 12, 2023.

(51) Int. Cl. H04N 19/159; H04N 19/176

(52) U.S. Cl. CPC H04N 19/159; H04N 19/176

(57) ABSTRACT

A method and apparatus for video coding using Extrapolation Intra Prediction (EIP) mode related modes are disclosed. According to this method, input data associated with a current block is received, wherein the input data comprises pixel data to be encoded at an encoder side or data associated with the current block to be decoded at a decoder side. The current block is encoded or decoded using a non-EIP (Extrapolated Intra Prediction) mode. One or more reference blocks pointed by one or more motion vectors, or one or more block vectors of the current block are determined. If said one or more reference blocks have target EIP information, the target EIP information is copied from said one or more reference blocks and stored in the current block, wherein the target EIP information stored at the current block is accessed by one or more subsequent blocks to derive prediction information.

### CROSS REFERENCE TO RELATED APPLICATIONS

The present invention is a non-Provisional application of and claims priority to U.S. Provisional Patent Application No. 63/589,656, filed on Oct. 12, 2023. The U.S. Provisional patent application is hereby incorporated by reference in its entirety.

### FIELD OF THE INVENTION

The present invention relates to video coding system using Extrapolation Intra Prediction (EIP) mode. In particular, the present invention relates to copying EIP information from a block associated with EIP information and storing the EIP information in a current block when the current block is not coded in EIP, where the EIP information is accessed by one or more subsequent blocks to derive prediction information.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc. In order to improve the coding performance for a system using Extrapolated Intra Prediction mode, methods and apparatus of using EIP mode are disclosed.

### BRIEF SUMMARY OF THE INVENTION

A method and apparatus for video coding using Extrapolation Intra Prediction (EIP) mode related modes are disclosed. According to this method, input data associated with a current block is received, wherein the input data comprises pixel data to be encoded at an encoder side or data associated with the current block to be decoded at a decoder side. The current block is encoded or decoded using a non-EIP (Extrapolated Intra Prediction) mode. One or more reference blocks pointed by one or more motion vectors, or one or more block vectors of the current block are determined. If said one or more reference blocks have target EIP information, the target EIP information is copied from said one or more reference blocks and stored in the current block, wherein the target EIP information stored at the current block is accessed by one or more subsequent blocks to derive prediction information.

In one embodiment, said one or more block vectors are associated with a current luma block of the current block if the current block is coded in IBC (Intra Block Copy) or IntraTMP (Intra Template Matching Prediction) mode. In one embodiment, if said one or more reference blocks located according to said one or more block vectors or said one or more motion vectors are not EIP coded, but have first EIP information stored in said one or more reference blocks, the first EIP information stored is used as the target EIP information. In one embodiment, if said one or more reference blocks correspond to multiple reference blocks and only one of the multiple reference blocks has first EIP information, the first EIP information is used as the target EIP information. In one embodiment, if multiple reference blocks have first EIP information, the target EIP information is derived by combining corresponding EIP models associated with all or part of the multiple reference blocks.

In one embodiment, if multiple reference blocks have first EIP information, the target EIP information is copied from the first EIP information of a target reference block of the multiple reference blocks according to one or more pre-defined rules. In one embodiment, an EIP-coded reference block is selected as the target reference block of the multiple reference blocks. In another embodiment, an intra-coded, inter-coded, or IBC coded reference block is selected as the target reference block of the multiple reference blocks. In one embodiment, a shortest-distance reference block to the current block according to a distance measure is selected as the target reference block of the multiple reference blocks. In one embodiment, the distance measure corresponds to Euclidean distance, Manhattan distance, Minkowski distance, horizontal distance, or vertical distance. In one embodiment, a smallest-distortion reference block to the current block according to a distance measure is selected as the target reference block of the multiple reference blocks.

In one embodiment, if the current block is inter-coded with bi-directional prediction and both reference blocks located by said one or more motion vectors of the current block have stored EIP information, one of the reference blocks is selected based on a set of pre-defined rules. In one embodiment, said one or more motion vectors of the current block are located at centre or top-left corner of the current block, an MVP (Motion Vector Prediction) of the current block, or a combination of MVP and MVD (Motion Vector Difference) of the current block. In one embodiment, the set of pre-defined rules comprises dependence on POC (Picture Order Count) distances between reference pictures associated with the reference blocks and a current picture respectively. In one embodiment, the set of pre-defined rules comprises dependence on QP (Quantization Parameter) values of the reference blocks.

In one embodiment, position of a target block located by one motion vector is restricted to be in a collocated CTU row in a reference picture of a current CTU row. In one embodiment, if the position of the target block is above the collocated CTU row, the position is mapped to a top line of the collocated CTU row and EIP information from a mapped position is then copied and stored in the current block. In one embodiment, if the position of the target block is below the collocated CTU row, the position is mapped to a bottom line of the collocated CTU row and EIP information from a mapped position is then copied and stored in the current block.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIGS. 2A-C illustrate three types (FIG. 2A: Left-Top area, FIG. 2B: Top area, and FIG. 2C: Left area) of reconstructed areas used to derive filter coefficients for EIP.

FIG. 3 illustrates three types of filter shapes with fifteen inputs and generate one output for EIP process.

FIG. 4 illustrate an example of scanning order for generating predictions for different positions in the current block by a diagonal order.

FIG. 5 illustrates examples of square EIP filters.

FIG. 6 illustrates examples of horizontal-shaped EIP filters.

FIG. 7 illustrates examples of vertical-shaped EIP filters.

FIG. 8 illustrates examples of diamond-shaped EIP filters.

FIG. 9 illustrates an example of positions of spatial merge candidate.

FIG. 10 illustrates an exemplary pattern of the non-adjacent spatial merge candidates.

FIG. 11A (Pattern 1) and FIG. 11B (Pattern 2) illustrate two different patterns of non-adjacent spatial neighbouring candidates according to pre-defined positions and a pre-defined order.

FIG. 12 illustrates an example of EIP information propagation, where the dash-lined blocks (i.e., A, E, G) are coded in EIP.

FIG. 13 illustrates another example of EIP information propagation.

FIG. 14 illustrates examples of mapping positions outside of the collocated CTU row to positions inside the collocated CTU row.

FIG. 15 illustrates an example of EIP information propagation with motion vectors and block vectors, where the block with dash line (i.e., A) is coded in EIP.

FIG. 16 illustrates an example of EIP information propagation with collocated position. The blocks with dash line (i.e., A) are coded in EIP.

FIG. 17 illustrates a flowchart of an exemplary video coding system that copies EIP information from a non-EIP coded block and stores the EIP information in a current block for access by subsequent blocks to derive prediction information according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### The Extrapolation Intra Prediction (EIP)

In JVET AD0081, a method “extrapolation intra prediction” is proposed. According to AD0081, the application of EIP is restricted to the block size not greater than 32×32 and intra slice only. Since the EIP process according to AD0081 generates the predictor for each sample in one block (i.e., the process generates the predictor sample by sample in one block), this process is given an alternative name as “multiple source sample-based prediction” is this current disclosure.

### Obtaining the Min, Max, and Offset Value for EIP

Similar to CCCM (Convolutional Cross-Component Model) mode, an offset value is removed when feeding the inputs to the EIP filter. The top-left reconstructed pixel from a pre-defined neighbouring area of the current block is used as the offset value for EIP prediction. The min and max values are obtained from reconstructed pixels in the pre-defined reconstructed area of the current block.

### Calculation of Filter Coefficients for EIP

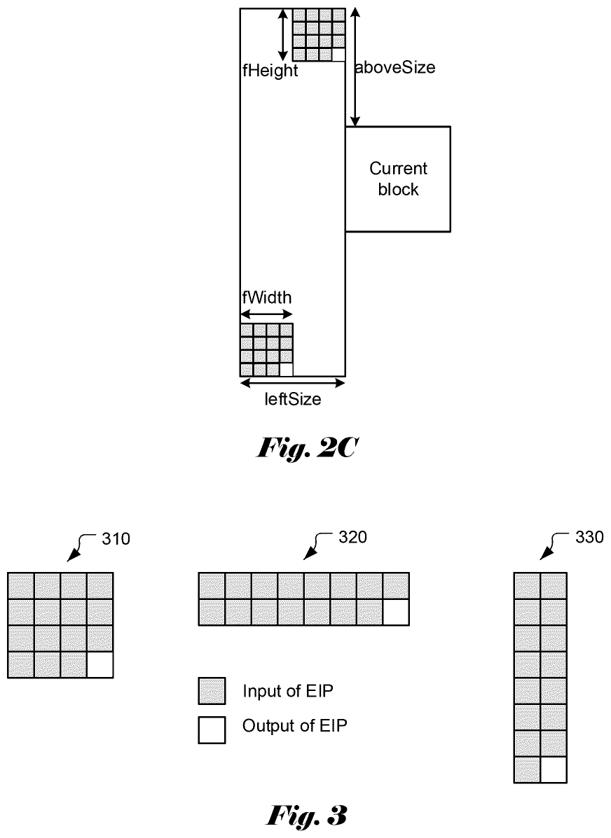

Three types of reconstructed areas and three filter shapes are proposed as shown in FIG. 2 and FIG. 3 respectively. In FIG. 2, the three reconstructed areas correspond to Left-Top area (FIG. 2A), Top area (FIG. 2B), and Left area (FIG. 2C). The size of reconstructed area depends on the min (blockWidth, blockHeight) and the selected filter shape. For example, when the current block is an 8×16 block and the selected filter shape is 4×4. The aboveSize of reconstructed area is min (8, 16)+4−1=11, and the leftSize of reconstructed area is min (8, 16)+4−1=11. In FIG. 3, the three filter shapes correspond to square 310, horizontal strip 320, and vertical strip 330. The selected filter moves in the selected reconstructed area with a one-pixel step to collect input samples and output samples of EIP. The auto-correlation matrix and cross-correlation vector are constructed while removing the offset value from input samples and output samples. Then, the EIP coefficients are obtained by the same method in CCCM.

### Prediction of Current Block for EIP

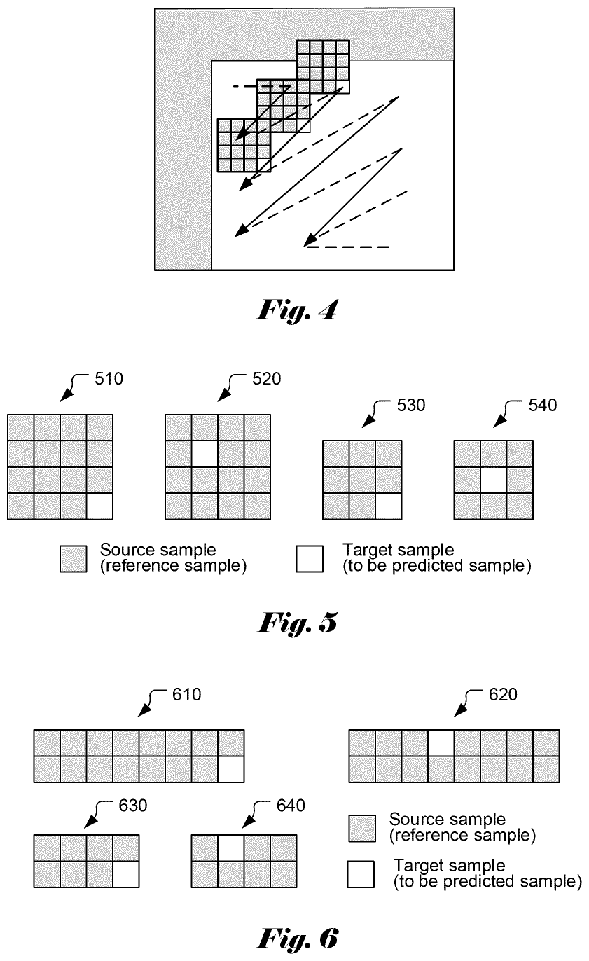

The EIP mode generates predictions for the current block from the top-left position to the bottom-right position by a diagonal prediction order, as shown in FIG. 4, where the arrows indicate the moving direction of the 4×4 filter.

To reduce the prediction error, the min and max values from the neighbouring reconstructed area are applied to restrict the output range of each predicted value.

The calculation for predicted samples in the test is shown as follows,

$${pred}_{( x , y )} = clip ( min , max , {\sum }_{i = 0}^{14} ( {c}_{i} \times ( {t}_{( x - x offset , y - y offset )} - offset ) ) + offset )$$

where pred_{(x,y)} is the predicted value at (x, y) in the current block. min, max and offset are the values described above. cᵢ is the i^{th} coefficient of the derived EIP filter, the index of the coefficients is from 0 to 14, t_{(x-xoffset,y-yoffset)} is reconstructed or predicted value used for the current position's prediction.

### Intra Template Matching

Intra template matching prediction (IntraTMP) is a special intra prediction mode that copies the best prediction block from the reconstructed part of the current frame, whose L-shaped template matches the current template. For a pre-defined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a pre-defined search area.

Sum of Absolute Differences (SAD) is used as a cost function.

Within each region, the decoder searches for the template that has the smallest SAD with respect to the current one and uses its corresponding block as a prediction block.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range.

In this disclosure, methods and apparatus to improve performance for video coding systems using EIP mode are disclosed.

### I. Extension of EIP

In the first embodiment, various patterns of sources (i.e., various filter shapes) are defined for the multiple source sample-based prediction as illustrated below. The proposed prediction scheme can be applied to luma component, chroma component or both. It is noted that each source sample (i.e., the input to the filter) can be a reconstructed sample, or a predictor sample generated by the multiple source sample-based prediction. When neither the reconstructed sample nor the predictor sample is available for that source sample, a default sample can be used. The default sample can be a pre-defined value such as the middle value within the full range of the sample value. The default sample can also be the predictor generated by the existing intra prediction method such as TIMD, DIMD, CCLM, CCCM, Planar mode, DC mode, Angular intra prediction modes, MIP and so on.

### Type 1 (Square Shape):

As shown in the FIG. 5, N×N−1 source samples are used to generate the predictor for the target (to be predicted) sample. The target sample can be any sample within the N×N block. In FIG. 5, two 4×4 patterns (510 and 520) and two 3×3 patterns (3×3) are shown.

### Type 2 (Horizontal Shape):

As shown in the FIG. 6, M×N−1 (M>N) source samples are used to generate the predictor for the target (to be predicted) sample. The target sample can be any sample within the M×N block. In FIG. 6, two 8×2 patterns (610 and 620) and two 4×2 patterns (630 and 640) are shown.

### Type 3 (Vertical Shape):

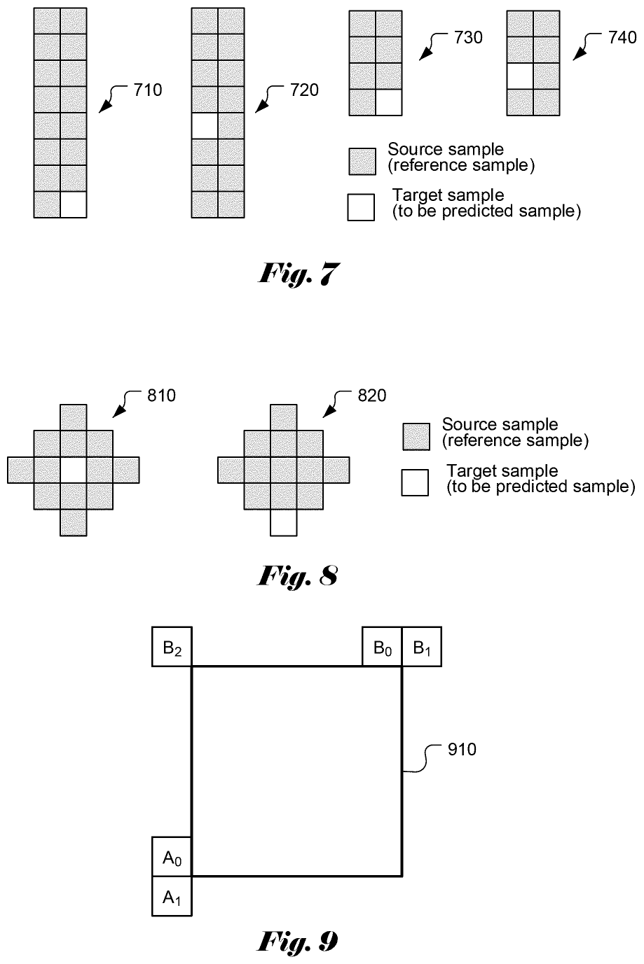

As shown in the FIG. 7, M×N−1 (M<N) source samples are used to generate the predictor for the target (to be predicted) sample. The target sample can be any sample within the M×N block. In FIG. 7, two 2×8 patterns (710 and 720) and two 2×4 patterns (730 and 740) are shown.

### Type 4 (Diamond Shape):

As shown in the FIG. 8, an M-tap diamond shape kernel is used in multiple-source sample-based prediction. M−1 source samples are used to generate the predictor for the target (to be predicted) sample. The target sample can be any sample within the M-tap diamond shape kernel. In FIG. 8, two 5×5 patterns (810 and 820) are shown. The terms “kernel” and “filter shape” are used interchangeably in this disclosure.

### II. EIP Model Inheritance

### II.1 Inheriting EIP Information

In one embodiment, all or part of the EIP information of (associated with) an inherited EIP model can be stored together with the inherited EIP model parameters. All or part of the EIP information associated with an EIP model can be stored together with the EIP model parameters. The EIP information and the EIP model parameters are stored associated with a block. EIP model parameters refer to EIP filter coefficients as described in the sections entitled as “Calculation of filter coefficients for EIP” and “Prediction of Current Block for EIP”.

The EIP information includes, but not limited to, template region selection type (e.g., EIP_T, EIP_L or EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag or model parameters. The template region refers to the reconstructed area of EIP. EIP_T, EIP_L and EIP_LT refer to the Top area (FIG. 2B), Left area (FIG. 2C) and Left-Top area (FIG. 2A) respectively. The kernel type refers to the filter shape type.

In one embodiment, a propagation flag can be stored in the EIP information. This information describes whether the EIP information is copied from a reference block as described in Section “Propagated EIP Information”. As described in Section “Propagated EIP Information”, if a block uses EIP filter, the EIP information of the current block is derived and stored. The propagation flag of current block's EIP information is set to false. If a block does not use EIP filter, and the EIP information of the current block is derived by copying the EIP information from a reference block. The propagation flag of current block's EIP information is then set to true.

In another embodiment, the EIP information can include information to indicate the source of the propagated EIP information. For example, as described in Section “Propagated EIP Information”, the reference block from which the EIP information is copied can be a block located by the block vector of the current block, a block located by the motion vector of the current block, or a collocated block of the current block.

### II.2 Inheriting Spatial Neighbouring Model Parameters

In one embodiment, the inherited model parameters can be from a block that is an immediate neighbouring block. The models from blocks at pre-defined positions are added into the candidate list in a pre-defined order. For example, the pre-defined positions can be the positions as illustrated in the FIG. 9 for the current block 910, and the pre-defined order can be B₀, A₀, B₁, A₁ and B₂, or A₀, B₀, B₁, A₁ and B₂.

In another embodiment, the pre-defined positions include the positions immediately above the centre position of the top line of the current block if W is greater than or equal to TH. Assume the position of the current chroma block is at (x, y), the pre-defined positions can be (x+(W>>1), y−1) or (x+(W>>1)−1, y−1). The pre-defined positions also include the positions at the immediate left of the centre position of the left line of the current block if H is greater than or equal to TH. The pre-defined positions can be (x−1, (H>>1)) or (x−1, (H>>1)−1) position. W and H are the width and height of the current block, TH is a threshold value which can be 4, 8, 16, 32, or 64.

### II.3 Inheriting Temporal Neighbouring Model Parameters

In another embodiment, if the current slice/picture is a non-intra slice/picture, the inherited model parameters can from the block in the previous coded slices/pictures. For example, the current block position is at (x, y) and the block size is w×h. The inherited model parameters can from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. Δx and Δy can be zero.

In one embodiment, if the current block is inter uni-prediction, Δx and Δy are set to the horizontal and vertical motion vector in either reference picture list 0 or 1 depending on which list is used for the current block.

For another embodiment, if the current block is inter uni-prediction, the motion vector of the list 0 or list 1 can be scaled to the pre-defined collocated picture. For another embodiment, if the current block is inter bi-prediction, the motion vectors of the list 0 and/or list 1 can be scaled to the pre-defined collocated picture.

In one embodiment, if the current slice/picture is a non-intra slice/picture, the inherited model parameters can be from the block in the previous coded slices/pictures. In one embodiment, the current block position is at (x, y) and the block size is w×h. The two value sets αx and αy are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{y n} \} , {α}_{y i} < {α}_{y j} if i < j$$

All values in αₓ and α_{y} are positive numbers. Let (x_{mid}, y_{mid})=(x+w/2, y+h/2). The inherited model parameters can be from the block at positions (x_{mid}+αₓᵢ×w, y_{mid}+α_{yi}×h), (x_{mid}+αₓᵢ×w, y_{mid}−α_{yi}×h), (x_{mid}−αₓᵢ×w, y_{mid}+α_{yi}×h), (x_{mid}−αₓᵢ×w, y_{mid}−α_{yi}×h), (x_{mid}+αₓᵢ×w, 0), (x_{mid}−αₓᵢ×w, 0), (0, y_{mid}+α_{yi}×h), (0, y_{mid}−α_{yi}×h), (x_{mid}+αₓᵢ×w, y_{mid}), (x_{mid}−αₓᵢ×w, y_{mid}), (x_{mid}, y_{mid}+α_{yi}×h), (x_{mid}, y_{mid}−α_{yi}×h) of the previous coded slices/picture.

In one sub-embodiment, αₓ=α_{y}. For example, αₓ=ay={1, 2, 3, 4, 5}.

In another sub-embodiment, αₓ≠α_{y}. For example, αₓ={1/2, 1, 3/2, 2, 5/2} and α_{y}={1, 2, 3, 4, 5}.

In another embodiment, the current block position is at (x, y) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h), (x+αₓᵢ×w, y), (x−αₓᵢ×w, y), (x, y+α_{yi}×h), (x, y−α_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, αₓ={1/2, 1, 3/2, 2, 5/2} and α_{y}={1, 2, 3, 4, 5}.

In another embodiment, the current block position is at (x, y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at (x, y), (x+w−1, y), (x, y+h−1), (x+w−1, y+h−1), (x+w/2, y+h/2). For another example, the positions are outside of the corresponding area of the current encoding block, i.e., x′<x+ or x′>x+w, or y′<y or y′>y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the previous coded picture which the inherited parameter model is from, i.e., the collocated picture, is one of the pictures in the reference lists. The previous coded picture which the inherited parameter model is from is called the collocated picture hereafter.

In one embodiment, the collocated picture is the same as the collocated reference picture of TMVP (Temporal Motion Vector Prediction) of inter merge mode. In another embodiment, the collocated picture can be different from the collocated reference picture of TMVP of inter merge mode.

In one embodiment, the collocated picture is signalled in the picture/slice header. The reference list and the reference index are signalled in the picture/slice header. For example, the collocated picture is selected as L0[0]. For another example, the collocated picture is selected as L1[0] In one embodiment, the number of signalled collocated picture can be more than one.

For example, the number of signalled collocated picture is 2. The temporal candidates from both collocated pictures can be inherited.

In one embodiment, the collocated picture is selected as the picture in the reference lists whose POC difference between the picture and the current picture is the smallest.

In still another embodiment, the picture with the smaller QP is selected as the collocated picture.

In still another embodiment, the picture with the larger QP is selected as the collocated picture.

In one embodiment, if one picture in the reference list is rescaled (i.e, the RprConstraintsActiveFlag of the collocated picture is true), which means one or more of the following seven parameters of the collocated picture are different from those of the current picture: 1) the picture width in luma samples (pps_pic_width_in_luma_samples), 2) the picture height in luma samples (pps_pic_height_in_luma_samples), 3) the scaling window left offset (pps_scaling_win_left_offset), 4) the scaling window right offset (pps_scaling_win_right_offset), 5) the scaling window top offset (pps_scaling_win_top_offset), 6) the scaling window bottom offset (pps_scaling_win_bottom_offset), and 7) the number of sub pictures−1 (sps_num_subpics_minus1), the picture is not selected as the collocated picture.

In one embodiment, the rules to select/not select the collocated pictures described in the paragraphs above can be combined. For example, the collocated picture is selected out of the un-rescaled pictures in the reference lists. The collocated picture is selected as the picture whose POC difference between the picture and the current picture is the smallest.

In one embodiment, when the collocated picture is rescaled, inheriting EIP information from the collocated picture is disabled.

In one embodiment, when the collocated picture is rescaled, the positions where the inherited model are from can be scaled according to the scaling ratio. The scaling ratio is derived based on the scaling window of the current picture and the collocated picture. Let the position be (x, y), the scaled position be (x′, y′) and the scaling ratio be R. The scaled position can be (x/R, y/R) or (x/R, y/R) after rounding. The rounding method used can be, but not limited to, the following methods: rounding toward negative infinity, rounding toward positive infinity, rounding toward zero, or rounding to the nearest integer (e.g., rounding away from zero, rounding half up, rounding half down, . . . ).

In one embodiment, the collocated picture and the positions where the inherited parameter model is from are determined by the motion vector of a neighbouring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. Δx and Δy are set to the L0 horizontal and vertical motion vector of the neighbouring block.

In another embodiment, when selecting the neighbouring block where the motion vector is from, there can be a list of pre-defined positions. The positions are placed according to a checking order. For example, the positions can be the spatial position described in Section “Inheriting spatial neighbouring model parameters”.

For another example, the positions in the list are checked in a pre-defined checking order. For each position, the L0 motion vector is first checked, and then the L1 motion vector. For another example, the L1 motion vector is first checked, and then the L0 motion vector. The selected motion vector is the first whose reference picture is the collocated picture (i.e., the collocated picture is determined before selecting the neighbouring motion vector). In another embodiment, following the checking order, if the motion vector is not available (or valid) for the checking position, this checking position is bypassed and the next position is further checked.

### II.4 Inheriting Non-Adjacent Spatial Neighbouring Models

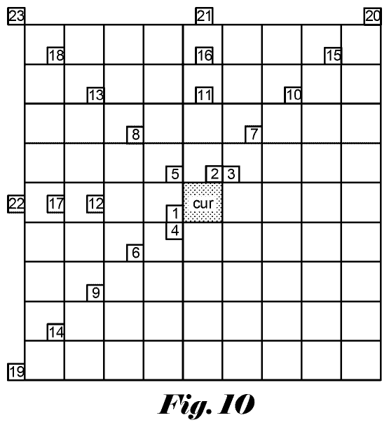

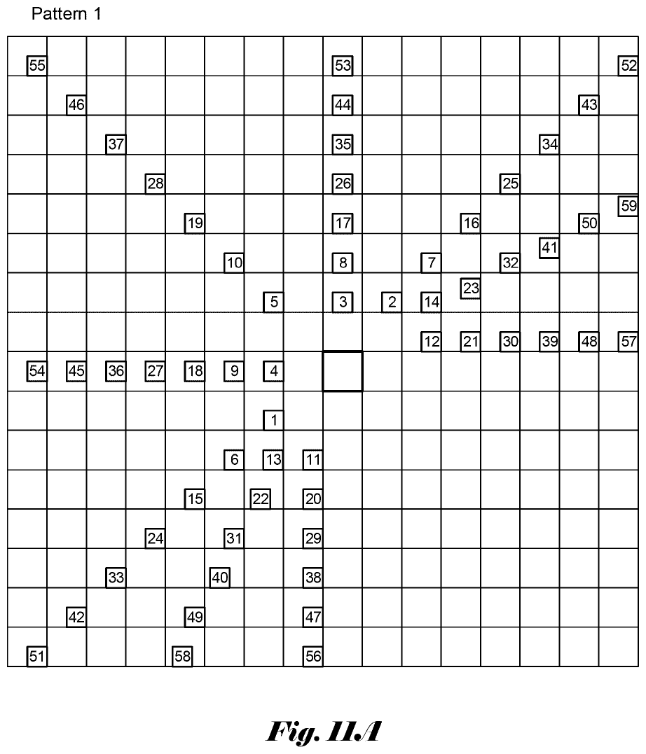

In one embodiment, the inherited model parameters can be from blocks that are spatial neighbouring blocks. The models from blocks at pre-defined positions are added into the candidate list in a pre-defined order. For example, the pattern of the positions and order can be as the pattern depicted in FIG. 10. Each small square represents a candidate position and the number inside the square indicates the pre-defined order. The distance between each position and current block are based on the width and height of current coding block.

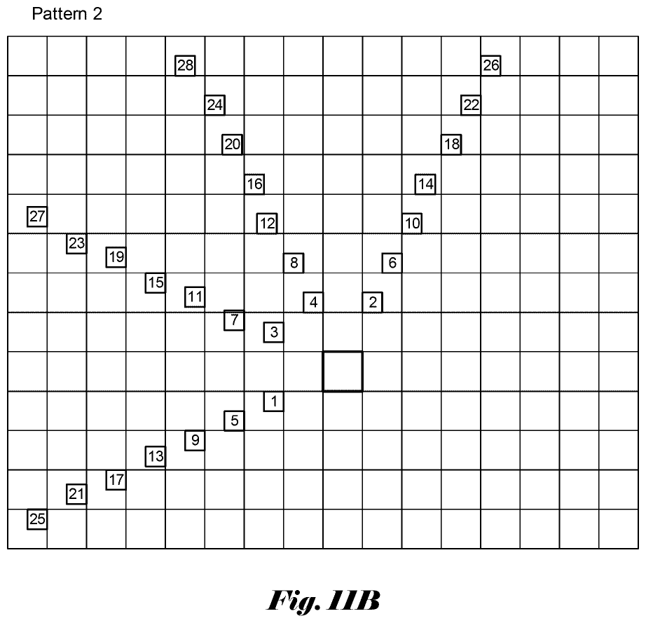

For still another embodiment, the maximum number of inherited models from non-adjacent spatial neighbours are smaller than the number of pre-defined positions. For example, if the pre-defined positions are as depicted in FIG. 11A and FIG. 11B, where there are 2 search patterns. The candidates from the positions in search pattern 1 (FIG. 11A) are added into the candidate list before the candidates from the positions in search pattern 2 (FIG. 11B). If the maximum number of inherited models from non-adjacent spatial neighbours that can be added into the candidate list is N, the models from positions in search pattern 2 (FIG. 11B) are added into the candidate list only when the number of available models from positions in search pattern 1 (FIG. 11A) is smaller than N.

II.5 Inheriting Model Parameters from History Table

In one embodiment, the inherited model parameters can be from a EIP model history table. The models in the history table can be added into the candidate list according to a pre-defined order. In one embodiment, the adding order of historical candidate can be from the beginning of the table to the end of the table. In another embodiment, the adding order of historical candidate can be from a certain pre-defined position to the end of the table. In another embodiment, the adding order of historical candidate can be from the end of the table to the beginning of the table. In another embodiment, the adding order of historical candidate can be from a certain pre-defined position to the beginning of the table. In another embodiment, the adding order of historical candidate can be in an interleaved manner (e.g., the first added candidate is from the beginning of the table, the second added candidate is from the end of the table and so on).

In one embodiment, single EIP model history table can be maintained for storing the previous EIP model, and the history table can be reset at the start of the current picture, current slice, current tile, every M CTU rows or every N CTUs, N and M can be any value greater than 0. In another embodiment, the EIP model history table can be reset at the end of the current picture, current slice, current tile, current CTU row or current CTU.

### II.6 Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the candidate list can include spatial neighbouring candidates, temporal neighbouring candidate, historical candidates, non-adjacent neighbouring candidates.

In another embodiment, if all the pre-defined neighbouring and historical candidates are added, but the maximum candidate number is not reached, some default candidates are added into the candidate list until the maximum candidate number is reached.

In another embodiment, a default candidate can be a shortcut to indicate an EIP mode (i.e., uses the current neighbouring reconstruction samples to derive EIP models) rather than inheriting parameters from neighbours. For example, default candidate can be EIP_LT, EIP_L, EIP_T.

### II.7 Signalling the Inherited Candidate in the List

In one embodiment, an on/off flag is signalled to indicate if the current block inherits the EIP model information from neighbouring blocks or not. The flag can be signalled per CU/CB, per PU, per TU/TB, or per colour component. A high-level syntax can be signalled in SPS, PPS, PH or SH to indicate if the proposed method is allowed for the current sequence, picture, or slice.

In one embodiment, if the current block inherits the EIP model parameters from neighbouring blocks, the inherited candidate index is signalled. The index can be signalled (e.g., signalled using truncate unary code, Exp-Golomb code, or fix length code) for each colour component.

II.8 Propagated EIP information

In one embodiment, after encoding/decoding a block, the EIP information of the current block is derived and stored in the current block. The stored EIP information can be referenced by the following coding blocks (i.e., subsequent coding blocks) when inheriting EIP information. The following coding blocks can inherit EIP information from the current block. The definition of EIP information is in Section “Inheriting EIP information”. The stored EIP information can be inherited as, but not limited to, the following types of candidates: spatial candidates (as in Section “Inheriting spatial neighbouring model parameters”), non-adjacent candidates (as in Section “Inheriting non-adjacent spatial neighbouring models”), temporal candidates (as in Section “Inheriting temporal neighbouring model parameters”), historical candidates (as in Section “Inheriting model parameters from history table”).

In one embodiment, if the current block is coded with EIP mode, the EIP information related to the EIP mode is stored in the current block.

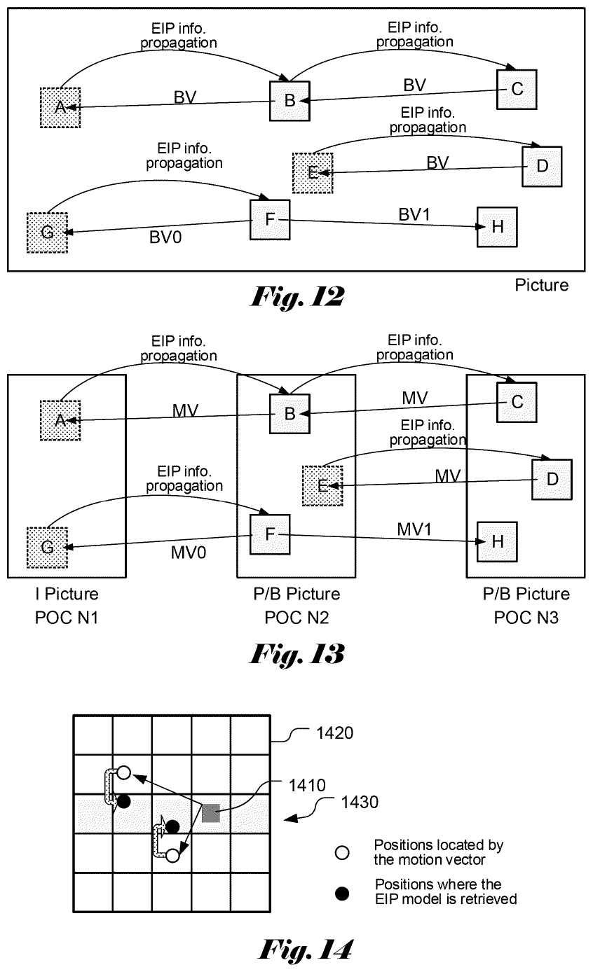

In one embodiment, if the current block is not coded with EIP, and there are one or more block vectors available in the current block, (e.g., the current block or the collocated luma block is coded in IBC or IntraTMP mode), the EIP information of the current block can be derived by copying the EIP information of the reference block located by the block vector. For example, as shown in FIG. 12, block B is not coded with EIP and there are block vectors available at block B. The reference block A is located by the block vector. The EIP information of the reference block A, which is coded with EIP, is copied and stored in block B.

In one embodiment, if the reference block located by the block vector is also not EIP coded, but there is EIP information stored in the reference block, the EIP information of the current block can be derived by copying the EIP information stored in the reference block. That is, even when the reference block is not EIP coded, as long as it has valid stored EIP information, the stored EIP information can be referenced (i.e., copied) by the current block. For example, as shown in FIG. 12, the current block C has block vector available, and its reference block B, which is not EIP coded, has EIP information stored. The EIP information of block B is copied and stored in block C. Since the EIP information stored in block B was copied from block A, the EIP information stored in block Cis originally from block A (i.e., the EIP information of block A is propagated to block C). By only accessing block B, block C can retrieve EIP information originally from block A.

In one embodiment, if the reference block located by the block vector is not EIP coded and does not have EIP information stored, no EIP information is stored for the current block.

In one embodiment, the block vectors used to derive the reference block are the block vectors at the centre of the block or the collocated luma block. In another embodiment, the block vectors used to derive the reference block is the block vectors at the top-left corner of the block or the collocated luma block.

In one embodiment, when the current block has multiple block vectors available (e.g., the block vector can be bi-directional, the block can have multiple IntraTMP block vectors), to derive the EIP information of the current block, if only one of the reference blocks located by the block vectors has EIP information, the EIP information from the reference block which has EIP information is copied to and stored in the current block. For example, as shown in FIG. 12, suppose block F has two block vectors and has two reference blocks G and H. Block G has EIP information and block H does not. The EIP information of block G is copied to and stored in block F.

For another embodiment, when the current block has multiple block vectors, and more than one of the reference blocks located by the block vectors have EIP information, one of the reference blocks is selected based on a set of pre-defined rules. The EIP information of the selected reference block is then copied and stored in the current block.

For one sub-embodiment, the reference block that is coded with EIP is selected.

For one sub-embodiment, the reference block that is intra coded is selected.

For one sub-embodiment, the reference block that is inter coded is selected.

For one sub-embodiment, the reference block that is IBC coded is selected.

For one sub-embodiment, the reference block whose distance to the current block is the smallest is selected. The EIP information of the selected reference block is copied to and stored in the current block. The distance between the reference block and the current block, located at (xᵣ, yᵣ) and (x_{c}, y_{c}) respectively, can be computed as d=\sqrt{(xᵣ−x_{c})²+(yᵣ−y_{c})²}. (xᵣ, yᵣ) and (x_{c}, y_{c}) can be the top-left, top-right, bottom-left, bottom-right, or centre positions of the reference block and the current block.

For one sub-embodiment, the reference block which has the smallest horizontal distance, |xᵣ−x_{c}|, is selected. The EIP information of the selected reference block is copied to and stored in the current block.

For another sub-embodiment, the reference block which has the smallest vertical distance, |yᵣ−y_{c}|, is selected. The EIP information of the selected reference block is copied to and stored in in the current block.

For one sub-embodiment, the EIP information of both reference blocks are applied on the template of the current block to generate the prediction of the template. The distortion between the prediction samples and the reconstructed samples of the template is computed. The reference block associated with the smaller distortion is selected.

For one sub-embodiment, the rules described previously can be combined, and not all the rules described previously need to be applied. For example, the reference block that is EIP coded is selected. If there are more than one EIP coded reference block, then the block that has the shortest distance to the current block among the EIP coded reference blocks is selected. If there are more than one EIP coded reference block whose distance to the current block is the smallest, the reference block that has the smallest horizontal distance, |xᵣ−x_{c}|, is selected. For another example, the reference block that is EIP coded is selected. If there are more than one EIP coded reference block, then the block that has the shortest distance to the current block among the EIP coded reference blocks is selected. If there is more than one EIP coded reference block whose distance to the current block is the smallest, the reference block that has smallest vertical distance, |yᵣ−y_{c}|, is selected. The EIP information of the selected reference block is copied to and stored in the current block.

In one embodiment, if the current block is not EIP coded and there are motion vectors available in the current block (e.g. the current block is inter-coded), the EIP information of the current block can be derived by copying the EIP information of its reference block in a reference picture, located by the motion vectors of the current block. For example, as shown in FIG. 13, block B is not EIP coded and there are motion vectors available at block B. The reference block A is located by the motion vector. The EIP information of the reference block A, which uses cross-component model, is copied and stored in block B.

For one embodiment, if the reference block located by the motion vector is not EIP coded either, but there is EIP information stored in the reference block, the EIP information of the current block can be derived by copying the EIP information stored in the reference block. That is, even when the reference block is not EIP coded, as long as it has valid stored EIP information, the stored EIP information can be referenced (i.e., copied) by the current block. For example, as shown in FIG. 13, the current block C has motion vector available, and its reference block B, which is not EIP coded, has EIP information stored. The EIP information of block B is copied and stored in block C. Since the EIP information stored in block B was copied from block A, the EIP information stored in block C is originally from block A (i.e., the EIP information of block A is propagated to block C). By only accessing block B, block C can retrieve EIP information originally from block A.

For one embodiment, if the reference block located by the motion vector is not EIP coded and does not have EIP information stored, no EIP information is stored for the current block.

In one embodiment, the motion vectors used to derive the reference block is the motion vectors at the centre of the current block or the collocated luma block. In another embodiment, the motion vector used to derive the reference block is the motion vectors at the top-left corner of the current block or the collocated luma block.

In one embodiment, the motion vector used to derive the reference block is the MVP (Motion Vector Prediction) of the current block. In another embodiment, the motion vectors used to derive the reference block is the combination of MVP and MVD of the current block.

For one embodiment, when the current block is inter-coded with bi-directional prediction, the EIP information from the reference block that has EIP information is copied to and stored in the current block if only one of the reference blocks located by the motion vectors has EIP information. For example, as shown in FIG. 13, suppose block F is inter-coded with bi-directional prediction, the two reference blocks located by the motion vectors are block G and block H. Block G has stored EIP information and block H does not. The EIP information of block G is copied to and stored in block F.

For another embodiment, when the current block is inter-coded with bi-directional prediction, and both reference blocks located by the motion vectors has stored EIP information, one of the reference blocks is selected based on a set of pre-defined rules. The EIP information of the selected reference block is then copied and stored in the current block.

For one sub-embodiment, the reference block that is EIP coded is selected.

For one sub-embodiment, the reference block that is intra coded is selected.

For one sub-embodiment, the reference block that is inter coded is selected.

For one sub-embodiment, the reference block that is IBC coded is selected.

For one sub-embodiment, the reference block whose reference picture has the smaller POC distance to the current picture is selected. The EIP information of the selected reference block is copied to and stored in the current block. As shown FIG. 13, block F is inter-coded with bi-directional prediction. The two reference blocks located by the motion vectors are block G and block H. Assume block G and block H both have stored EIP information, and |N1−N2| is smaller than |N3−N2|. Then block G is selected, and the EIP information of block G is copied to and stored in block F.

For one sub-embodiment, the reference block whose reference picture has the smaller QP difference from the current picture is selected. The EIP information of the selected reference block is copied to and stored in the current block. As shown in FIG. 13, block F is inter-coded with bi-directional prediction. The two reference blocks located by the motion vectors are block G and block H. Assume block G and block H both have stored EIP information. Assume the QPs of the pictures of POC N1, POC N2 and POC N3 are 27, 32, 33 respectively. Since |33-32| is smaller than |27-32|, block His selected, and the EIP information of block H is copied to and stored in block F.

For one sub-embodiment, the reference block whose reference picture has the smaller QP value is selected. For another sub-embodiment, the reference block whose reference picture has the larger QP values is selected.

For one sub-embodiment, if the POC distance of a reference picture to the current picture is greater than a threshold, the reference block is not selected.

For one sub-embodiment, the EIP information of both reference blocks are applied on the template of the current block to generate the prediction of the template. The distortion between the prediction samples and the reconstructed samples of the template is computed. The reference block associated with the smaller distortion is selected.

For one sub-embodiment, the rules described previously can be combined, and not all the rules described previously need to be applied. For example, the reference block that is EIP coded is selected. If both blocks are EIP coded, then the block whose reference picture has the smaller POC distance to the current picture is selected. If both blocks are EIP coded and have the same POC distance to the current picture, the reference block whose reference picture has the smaller QP difference from the current picture is selected. If both blocks are EIP coded, have the same POC distance to the current picture, and have the same QP difference from the current picture, then the reference block whose reference picture has the smaller QP value is selected. For another example, the block whose reference picture has the smaller POC distance to the current picture is selected. If both blocks have the same POC distance to the current picture, the reference block whose reference picture has the smaller QP difference from the current picture is selected. If both blocks have the same POC distance to the current picture and have the same QP difference from the current picture, then the reference block whose reference picture has the smaller QP value is selected.

In one embodiment, when the reference picture located by the motion vector is rescaled (i.e, the RprConstraintsActiveFlag of the reference picture is true), which means one or more of the following seven parameters of the reference picture are different from those of the current picture: 1) the picture width in luma samples (pps_pic_width_in_luma_samples), 2) the picture height in luma samples (pps_pic_height_in_luma_samples), 3) the scaling window left offset (pps_scaling_win_left_offset), 4) the scaling window right offset (pps_scaling_win_right_offset), 5) the scaling window top offset (pps_scaling_win_top_offset), 6) the scaling window bottom offset (pps_scaling_win_bottom_offset), and 7) the number of sub pictures−1 (sps_num_subpics_minus1), it is considered as no EIP information can be located by this motion vector. Thus, no EIP information is retrieved and stored.

In one embodiment, when the reference picture located by the motion vector is rescaled, the position of the reference block can be scaled according to the scaling ratio. The scaling ratio is derived based on the scaling window of the current picture and the collocated picture. Let the position of the reference block be (x, y), the scaled position of the reference block be (x′, y′) and the scaling ratio be R. The scaled position can be (x/R, y/R) or (x/R, y/R) after rounding. The rounding method used can be, but not limited to, the following methods: rounding toward negative infinity, rounding toward positive infinity, rounding toward zero, or rounding to the nearest integer (e.g., rounding away from zero, rounding half up, rounding half down, . . . ).

In one embodiment, the position located by the motion vector has to be in the collocated CTU row 1430 in the reference picture 1420 of the current CTU row in FIG. 14, where the collocated block 1410 is indicated. As depicted in FIG. 14, if the position (indicated by a small circle) located by the motion vector is above the collocated CTU row, the position is mapped to the position (indicated by a block dot) in the top line of the collocated CTU row 1430. If the position (indicated by a small circle) located by the motion vector is below the current CTU row, the position is mapped to the position (indicated by a block dot) in the bottom line of the collocated CTU row. The EIP information from the mapped position is then copied and stored in the current block. Assume the minimum and the maximum vertical positions of the current CTU row are Y1 and Y2 respectively. Assume the position located by the motion vector is (Xm, Ym). If Xm<Y1, then the position is changed to (Xm, Y1). The EIP information at position (Xm, Y1) is copied to the current block and stored. If Ym>Y2, then the position is changed to (Xm, Y2). The EIP information at position (Xm, Y2) is copied to current block and stored.

In one embodiment, if the POC distance between the reference picture located by the motion vector and the current picture is greater than a pre-defined threshold, the motion vector and the reference block is considered unavailable.

In one embodiment, if the current block is inter-coded or there is a block vector available in the current block, the EIP information of the current block can be derived by copying the EIP information of the reference block located by the motion vector or the block vector. For example, as shown FIG. 15, the current block C has a block vector available, and its referenced block B has motion vector available. The EIP information of block B is first copied from block A. The EIP information of block B is then copied to block C. Hence the EIP information of block A is propagated to the current block C.

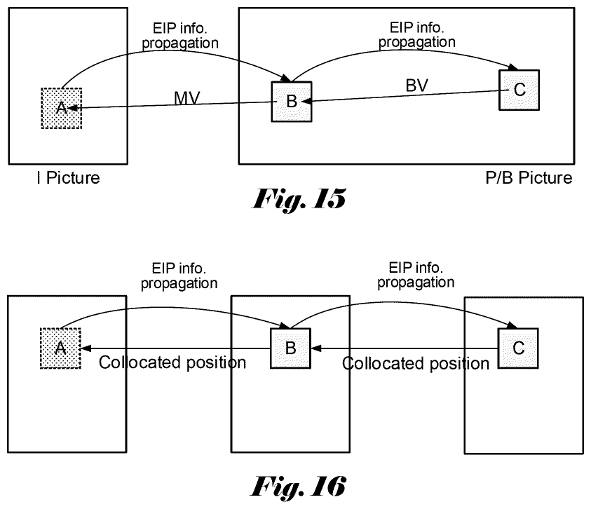

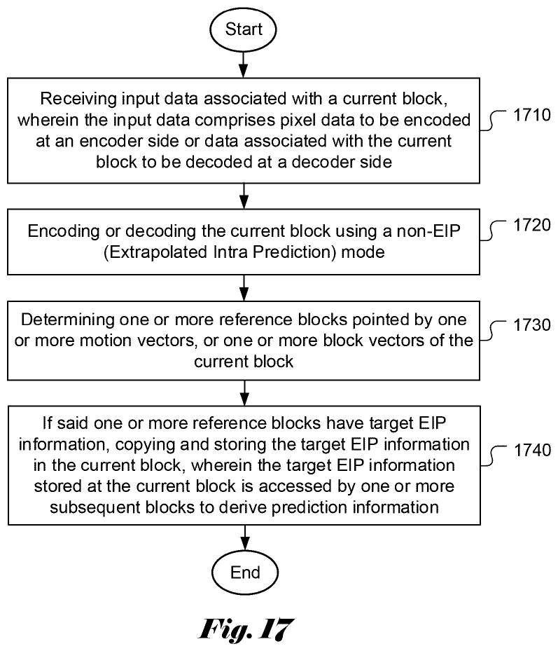

In one embodiment, as shown in FIG. 16, if the current block is not EIP coded and the current slice/picture is a non-intra slice/picture, the EIP information of the current block can be derived by copying the EIP information of its collocated block in a collocated picture. The definition of collocated picture can be found in the Section “Inheriting temporal neighbouring model parameters”

In one sub-embodiment, if the POC distance between the collocated picture and the current picture is greater than a pre-defined threshold, copying and storing the EIP information from the collocated picture will not be performed.

In one embodiment, when the current block is not EIP coded, the EIP information derivation process is performed after the encoding/decoding of the current picture.

In one embodiment, when multiple types of propagated EIP information are available for the current block, the propagated EIP information to be stored in the current block is determined based on a set of pre-defined rules. For example, if both the reference blocks located by the motion vectors and the reference block that is the collocated block of the current block in the collocated picture have valid EIP information, the EIP information of the reference blocks located by the motion vectors is copied and stored in the current block. For another example, the EIP information of the collocated block is copied and stored in the current block. For another example, the EIP information of the reference blocks located by the motion vectors is copied and stored in the current block after encoding/decoding a block. After encoding/decoding a picture, the EIP information of the collocated block is copied and stored in the current block (i.e., the EIP information of the reference blocks located by the motion vectors is replaced).

For example, if both the reference blocks located by the block vectors and the reference block that is the collocated block of the current block in the collocated picture have valid EIP information, the EIP information of the reference blocks located by the block vectors is copied and stored in the current block. For another example, the EIP information of the collocated block is copied and stored in the current block. For another example, the EIP information of the reference blocks located by the block vectors is copied and stored in the current block after encoding/decoding a block. After encoding/decoding a picture, the EIP information of the collocated block is copied and stored in the current block (i.e., the EIP information of the reference blocks located by the block vectors are replaced).

Any of the foregoing proposed methods of EIP information propagation can be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

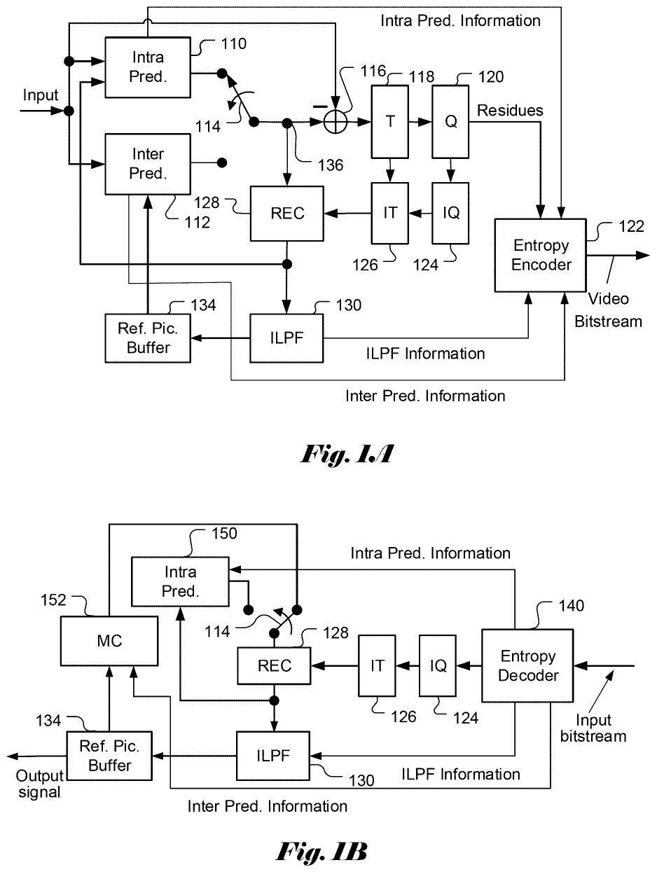

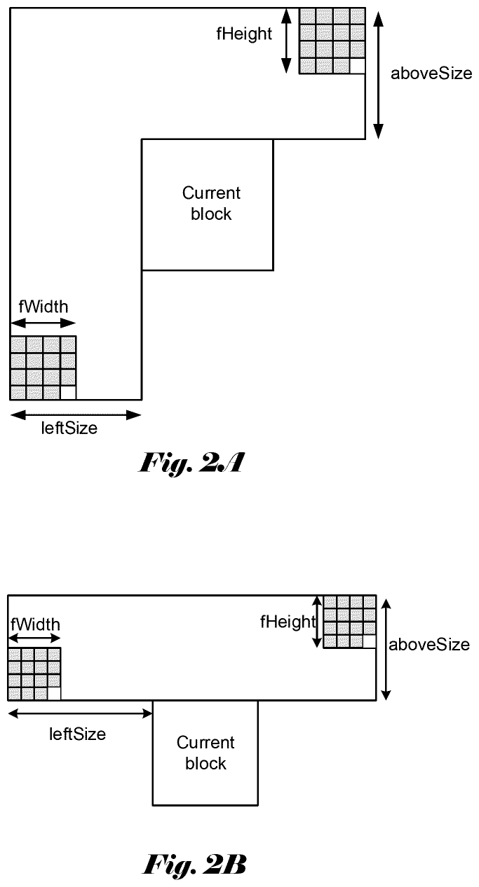

The proposed methods of EIP information propagation can be implemented in an encoder side or a decoder side. For example, any of the proposed methods of EIP information propagation can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 17 illustrates a flowchart of an exemplary video coding system that copies EIP information from a block associated with EIP information and stores the EIP information in a current block for access by subsequent blocks to derive prediction information according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block is received in step 1710, wherein the input data comprises pixel data to be encoded at an encoder side or data associated with the current block to be decoded at a decoder side. The current block is encoded or decoded using a non-EIP (Extrapolated Intra Prediction) mode in step 1720. One or more reference blocks pointed by one or more motion vectors, or one or more block vectors of the current block are determined in step 1730. If said one or more reference blocks have target EIP information, the target EIP information is copied from said one or more reference blocks and stored in the current block in step 1740, wherein the target EIP information stored at the current block is accessed by one or more subsequent blocks to derive prediction information.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side;
encoding or decoding the current block using a non-EIP (Extrapolated Intra Prediction) mode;
determining one or more reference blocks pointed by one or more motion vectors, or one or more block vectors of the current block; and
if said one or more reference blocks have target EIP information, copying and storing the target EIP information in the current block, wherein the target EIP information stored at the current block is accessed by one or more subsequent blocks to derive prediction information.

2. The method of claim 1, wherein said one or more block vectors are associated with a current luma block of the current block if the current block is coded in IBC (Intra Block Copy) or IntraTMP (Intra Template Matching Prediction) mode.

3. The method of claim 1, wherein if said one or more reference blocks located according to said one or more block vectors or said one or more motion vectors are not EIP coded, but have first EIP information stored in said one or more reference blocks, the first EIP information stored is used as the target EIP information.

4. The method of claim 1, wherein if said one or more reference blocks correspond to multiple reference blocks and only one of the multiple reference blocks has first EIP information, the first EIP information is used as the target EIP information.

5. The method of claim 1, wherein if multiple reference blocks have first EIP information, the target EIP information is derived by combining corresponding all or partial of EIP model parameters associated with the multiple reference blocks.

6. The method of claim 1, wherein if multiple reference blocks have first EIP information, the target EIP information is copied from the first EIP information of a target reference block of the multiple reference blocks according to one or more pre-defined rules.

7. The method of claim 6, wherein an EIP-coded reference block is selected as the target reference block of the multiple reference blocks.

8. The method of claim 6, wherein an intra-coded, inter-coded, or IBC coded reference block is selected as the target reference block of the multiple reference blocks.

9. The method of claim 6, wherein a shortest-distance reference block to the current block according to a distance measure is selected as the target reference block of the multiple reference blocks.

10. The method of claim 9, wherein the distance measure corresponds to Euclidean distance, Manhattan distance, Minkowski distance, horizontal distance, or vertical distance.

11. The method of claim 6, wherein a smallest-distortion reference block to the current block according to a distortion measure is selected as the target reference block of the multiple reference blocks.

12. The method of claim 11, wherein the distortion measure corresponds to measuring distortion between prediction samples and reconstructed samples of a template of the current block.

13. The method of claim 1, wherein if the current block is inter-coded with bi-directional prediction and both reference blocks located by said one or more motion vectors of the current block have stored EIP information, one of the reference blocks is selected based on a set of pre-defined rules.

14. The method of claim 13, wherein said one or more motion vectors of the current block are located at centre or top-left corner of the current block, an MVP (Motion Vector Prediction) of the current block, or a combination of MVP and MVD (Motion Vector Difference) of the current block.

15. The method of claim 13, wherein the set of pre-defined rules comprises dependence on POC (Picture Order Count) distances between reference pictures associated with the reference blocks and a current picture respectively.

16. The method of claim 13, wherein the set of pre-defined rules comprises dependence on QP (Quantization Parameter) values of the reference blocks.

17. The method of claim 13, wherein position of a target block located by one motion vector is restricted to be in a collocated CTU row in a reference picture of a current CTU row.

18. The method of claim 17, wherein if the position of the target block is above the collocated CTU row, the position is mapped to a top line of the collocated CTU row and EIP information from a mapped position is then copied and stored in the current block.

19. The method of claim 17, wherein if the position of the target block is below the collocated CTU row, the position is mapped to a bottom line of the collocated CTU row and EIP information from a mapped position is then copied and stored in the current block.

20. An apparatus for video coding, the apparatus comprising one or more electronic circuits or processors arranged to:
receive input data associated with a current block, wherein the input data comprises pixel data to be encoded at an encoder side or data associated with the current block to be decoded at a decoder side;
encode or decode the current block using a non-EIP (Extrapolated Intra Prediction) mode;
determine one or more reference blocks pointed by one or more motion vectors, or one or more block vectors of the current block; and
if said one or more reference blocks have target EIP information, copy and store the target EIP information in the current block, wherein the target EIP information stored at the current block is accessed by one or more subsequent blocks to derive prediction information.
